(19) United States
(12) Patent Application Publication
(10) Pub. No.: US 2016/0046289 A1
(43) Pub. Date: Feb. 18, 2016

(54) Method of Warning Road Users of Potential Danger Areas Caused by a Vehicle that is or Will be Performing a Maneuver

(71) Applicant: MAN Truck & Bus AG, Munchen (DE)

(72) Inventor: Norbert ELBS, Munchen (DE)

(21) Appl. No.: 14/821,190

(22) Filed: Aug. 7, 2015

(30) Foreign Application Priority Data
Aug. 12, 2014 (DE) 10 2014 011 915.7

(51) Int. Cl. B60W 30/095

(52) U.S. Cl. CPC B60W 30/095; B60W 2540/18; B60W 2540/20; B60W 2520/10; B60W 2710/30

(57) ABSTRACT

A method and an arrangement for warning road users of potential danger areas caused by a vehicle that is or is intended to be carrying out a driving maneuver use a control device that retrieves the steering angle of the vehicle by at least one steering angle sensor, retrieves the direction of travel from a driving speed selector and, from the steering angle and the direction of travel, cyclically determines a future road space that will be occupied within a specifiable time and speed in the event of maintaining the steering angle using a steering model of the vehicle accessible by the control device. The information thus obtained about the future occupied road space is used to control at least one projection device such that at least a part of the future occupied road space is made visible by a light projection onto the surface of the ground surrounding the vehicle.

### CROSS-REFERENCE TO RELATED APPLICATIONS

The present application claims priority of DE 10 2014 011 915.7, filed Aug. 12, 2014, which is incorporated herein by reference.

### BACKGROUND OF THE INVENTION

The invention relates to a method for warning road users of potential danger areas caused by a vehicle that is or will be carrying out a driving maneuver. The invention further relates to an arrangement for carrying out the method.

Vehicles, in particular commercial vehicles such as buses and trucks, are often difficult for the driver to see through owing to their size and shape, in particular if the same is carrying out or intends to carry out a driving maneuver. Driving maneuvers can be all maneuvers other than the “straight-ahead forward” maneuver. Moreover, it is difficult for other road users to estimate which road space such a vehicle will occupy when carrying out a driving maneuver. If a road user with a false estimation of the situation drives into the road space to be driven through, i.e. occupied, by the vehicle in the future, there is an acute danger of collision.

In order to improve the insight of the driver of the vehicle, a number of mirrors are already fitted to such vehicles as standard. Furthermore, camera arrangements have already been proposed in DE 298 18 214 U1 for example to be provided on vehicles and for their image signal to be shown on a display in order to help the driver with an insight into what is happening.

Another measure that is known for example from DE 10 2007 049 821 A1 or DE 10 2012 006 679 A1 provides for recording the vehicle surroundings by means of cameras and/or other sensors and to display them to the driver of the vehicle together with the actual vehicle and the future occupied road space on a display. This does improve the level of information for the driver of the vehicle, but in reality this has to transfer the representation onto the display, which is not always easy. Other road users within the surroundings of the vehicle do not know whether they are in or are near the danger area.

In order to warn other road users of dangers, it has already been proposed to provide signal sources on the vehicle that output signals that can be perceived by said road users in order to warn them of dangers such as reversing or a turning maneuver. It is thus known from DE 20 2006 010 763 U1 for example to provide on the right vehicle side of commercial vehicles a light and sound source that is activated during a turning maneuver and that outputs a visible and audible signal, so that road users present in the danger area, such as cyclists or motorcyclists, or any pedestrians are warned. Said measure does improve the level of information for said road users, but it leaves them unclear as to where the actual danger area lies.

Furthermore, a turn indicator for vehicles using a light source that can be set in the respective direction of travel is known from DE 452425 A, wherein the light source projects a direction symbol (arrow) onto the ground (road) either straight ahead or ahead and to the side during twilight, darkness or opaque weather that stands out against its surroundings owing to greater brightness.

### SUMMARY OF THE INVENTION

An object of the invention is to provide a method that automatically indicates to the driver of the vehicle and other road users a danger area that arises from a future or just started driving maneuver of a vehicle. Furthermore, it is also the object to provide an arrangement for carrying out the method.

According to an embodiment of the invention, a method is provided that warns road users of potential danger areas that are caused by a vehicle that is or will be carrying out a driving maneuver. The term “driving maneuver” should be understood to mean all maneuvers of a vehicle that include a change of the current (driving) status. The method provides that a control device cyclically retrieves the steering angle of the vehicle by at least one sensor and cyclically retrieves the direction of travel of the vehicle from a gear selection device. Using a steering model, the control device cyclically determines from the steering angle and the direction of travel of the vehicle a road space that will be occupied in the future within a specifiable time and speed in the event of maintaining the steering angle. With the information thus obtained about the future occupied road space, the control device controls at least one projection device such that at least part of the future occupied road space is made visible by a light projection onto the road surface around the vehicle. It is advantageously achieved by the method that both the driver of the vehicle and also the road users participating in the traffic events around the vehicle obtain direct information about where the danger area caused by the driving maneuver of the vehicle that is impending or that is in progress lies. The driver of the vehicle thereby directly identifies whether objects or other road users are in the danger area and the other road users affected by the driving maneuver identify whether they are already in the future danger area or are about to go there. If an involved road user determines that he is in the danger area or is moving towards the same, he can move into the safe area in a timely manner and is not relying on the driver of the vehicle recognizing the danger and terminating the driving maneuver.

In another embodiment of the method according to the invention, the control unit also cyclically retrieves the actual speed of the vehicle and uses it in determining the future occupied road space, so that in particular for rapid driving maneuvers, such as a lane change on a motorway, the projected future occupied road space advantageously realistically coincides with the actual occupied road space.

In order to still warn other road users when the vehicle is at rest and in the absence of any steering angle, for example if the vehicle is waiting at a crossing in order to enter a right of way road, or with the vehicle in motion and with a lack of a steering angle, for example immediately before a lane change on a motorway, i.e., if a turning maneuver or a lane change is imminent, the control unit, in addition to the steering angle, also cyclically polls a turn indicator and if the turn indicator is activated and the vehicle is stationary and/or the steering angle is unchanged the control unit, assuming a future driving maneuver in the direction indicated by the turn indicator, specifies a road space as the future occupied road space from memory values, and specifies that the thus specified future occupied road space is gradually transformed to the future occupied road space defined by the actual steering angle while the vehicle is moving. This enables a warning to be advantageously given to any affected road users before the existence of the danger area can be derived from the steering angle.

Likewise, a danger area arising in the future can advantageously be predicted in advance independently of the steering angle if the control device, in addition to the steering angle, also cyclically retrieves the route proposed by a navigation system and initially uses the steering angle to be adopted when following the proposed route to determine the future occupied road space, wherein in this case the thus assumed future occupied road is also gradually transformed into the future occupied road space defined by the actual steering angle while the vehicle is moving. In such a case, of course if the route proposed by the navigation system is not followed, an immediate changeover to the future occupied road space defined by the actual steering angle is carried out.

With multi-unit commercial vehicles, the determination of the future occupied road space is not only dependent on the steering angle of the steered axles, but on the overall configuration of the vehicle combination. Thus with articulated vehicles in an advantageous development of the method it is expedient that the control device also uses the articulation angle, in addition to the steering angle, to determine the future occupied road space. Accordingly, for vehicles with trailers the future occupied road space, for example when manoeuvring, is only determined if the control device, in addition to the steering angle of the steered axles, also uses the front tow bar angle and the rear tow bar angle of the trailer tow bar to determine the future occupied road space.

In a further embodiment, in order to advantageously make the projection and its information content more conspicuous, the control device superimposes at least one item of additional information on the projection of the future occupied road space. The projection of the future occupied road space and the additional information can also be carried out alternately in this case.

It is particularly useful if the superimposed information is graphical information, since the detection of graphical information, for example graphical symbols, is performed particularly rapidly by human beings. It is of particular advantage here if the graphical symbol has a known danger signalling meaning and is in particular a stop symbol.

It is of further advantage if the projection of the future occupied road space is carried out such that the same already takes a safety distance into account.

An arrangement for carrying out the method contains a control device in the form of a data processing device, wherein using a program said control device calculates the future road space occupied within a specifiable time from at least the steering angle, which the data processing device determines by polling a steering angle sensor, and the selected direction of travel, which the data processing device determines by means of a driving speed selector, and a steering model of the vehicle stored in the data processing device. Furthermore, at least one projection device is provided on the vehicle, which is controlled by the data processing device with the information about the future occupied road space such that the future occupied road space is indicated by a light projection onto the surface of the ground surrounding the vehicle.

In order to achieve adequate light intensity of the projection even in daylight, it is advantageous if the at least one projection device contains at least one laser light emitting laser source and at least one deflection device that deflects the laser beam within specified limits. Alternatively, it could also be provided that the laser source radiates through a variable aperture that maps the future occupied road space.

The laser source is advantageously controllable in respect of the intensity of the laser beam, so that in this way adaptation to different light conditions can be carried out. This can for example be carried out by pulsing the laser beam.

For the protection of other road users it is of advantage if the arrangement of the emission point of the laser beam on the vehicle is arranged such as to exclude the direct dazzling of road users in the traffic. The emission point is in this case preferably disposed on the vehicle as close to the ground as possible and radiates downwards at an angle.

The control of the intensity and/or the deflection of the laser beam is carried out advantageously such that the incident light, as the laser beam sweeps across a human eye, lies below a magnitude that is hazardous to the health of human eyes. Pulsing of the laser beam and/or a high deflection frequency of the deflecting device allow the amount of light to be reliably kept below a permitted magnitude when sweeping across a human eye.

In order to make the area identifying the future occupied road space visible as a whole, it is of advantage if the control of the deflection unit is designed such that the laser beam sweeps over the area identifying the future occupied road space in a raster pattern. During this the intensity of the projection can advantageously be increased if the control of the deflection unit is designed such that at least two successive rasters are selected such that the lines of the rasters intersect. By this measure the intercept points appear to the integrating human eye as particularly bright points and increase the detectability with a simultaneously low intensity of the laser beam.

Differently from or in addition to the previously described planar sweeping of the area identifying the future occupied road space, the control of the deflection unit may alternatively or additionally be designed such that the laser beam intermittently or continuously traces the periphery of the space identifying the future occupied road space in order to advantageously further increase its visibility.

It should be noted that the devices described above and also below that are used for control, polling or simulation purposes do not necessarily have to be implemented as hardware components. Rather, it is usual nowadays to design such components as software routines that are implemented by means of data processing devices. Common vehicles today comprise a number of such data processing devices that are networked together for data communications and that perform a wide variety of control, regulation, analysis, classification and data communication routines.

The method described above or the arrangement described above can be used in vehicles, in particular in commercial vehicles.

### BRIEF DESCRIPTION OF THE DRAWINGS

Further embodiments and advantages of the invention are described in detail below using the figures, the same reference characters being used for identical objects.

In the figures:

FIG. 1a is a schematic diagram in a bird's-eye view of a vehicle equipped with an arrangement according to the invention for carrying out a method of warning said users of a vehicle maneuver;

FIG. 1b is a schematic diagram in a side view of the vehicle of FIG. 1a;

FIG. 2 is a schematic block diagram of the arrangement for carrying out the method;

FIG. 3a is a schematic diagram of the angle relationships for an articulated tractor vehicle;

FIG. 3b is a schematic diagram of the angle relationships for a truck with a trailer;

FIG. 4 is a schematic diagram of a first traffic situation in a bird's-eye view;

FIG. 5 is a schematic diagram of a second traffic situation in a bird's-eye view;

FIG. 6a is a schematic diagram of third traffic situation in a side view; and

FIG. 6b is a schematic diagram of a third traffic situation in a bird's-eye view

### DETAILED DESCRIPTION OF THE PREFERRED EMBODIMENTS

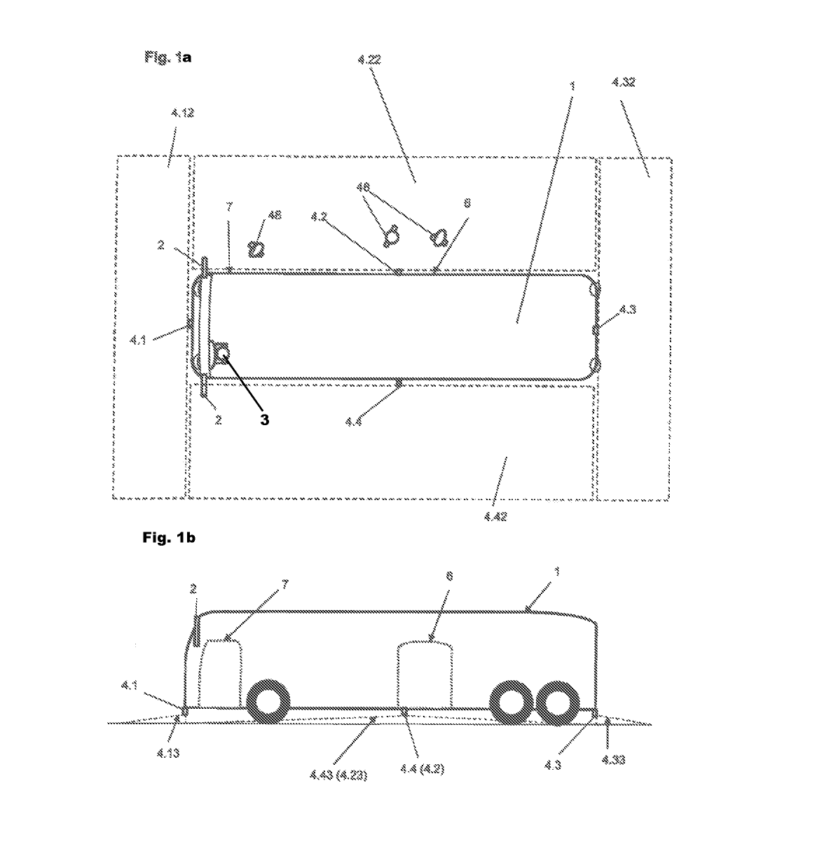

In order to clarify the situation for a vehicle equipped with the method according to the invention or the arrangement according to the invention for carrying out the method, in FIG. 1a a city bus 1 is shown in a bird's-eye view and in FIG. 1b the city bus is shown in a side view. As is usual, the city bus 1 is fitted with side mirrors 2 that allow the driver 3 to view the rear external region. According to the invention, projection devices 4.1, 4.2, 4.2, 4.4 are disposed on the city bus 1. As is apparent from the bird's-eye view shown at the top in FIG. 1, a first projection device 4.1 is located in the centre of the front region, a second projection device 4.2 is located in the centre of the right side region, a third projection device 4.3 is located in the centre of the rear region and a fourth projection device 4.4 is located in the centre of the right side region on the coach 1. It can be seen in the side view of the coach 1 shown at the bottom in FIG. 1 that the projection devices 4.1 to 4.4, which are facing the road surface 5, are disposed on the lower edge of the body of the coach 1. The projection devices are configured in this case such that they radiate towards the road surface 5 as shown by the radiation cones 4.11, 4.21, 4.31, 4.41 associated with the respective projection devices 4.1 to 4.4. Furthermore, the projection devices 4.1 to 4.4 according to said example are designed such that projection device 4.1 covers the areas 4.12, the projection device 4.2 covers the areas 4.22, the projection device 4.3 the areas 4.32 and the projection device 4.4 covers the areas 4.42. On the right side of the coach 1 in the direction of travel there are a rear entry door 6 and a front entry door 7; people 48 are also shown next to the city bus 1 on said right side, as can be seen from the top part of the representation.

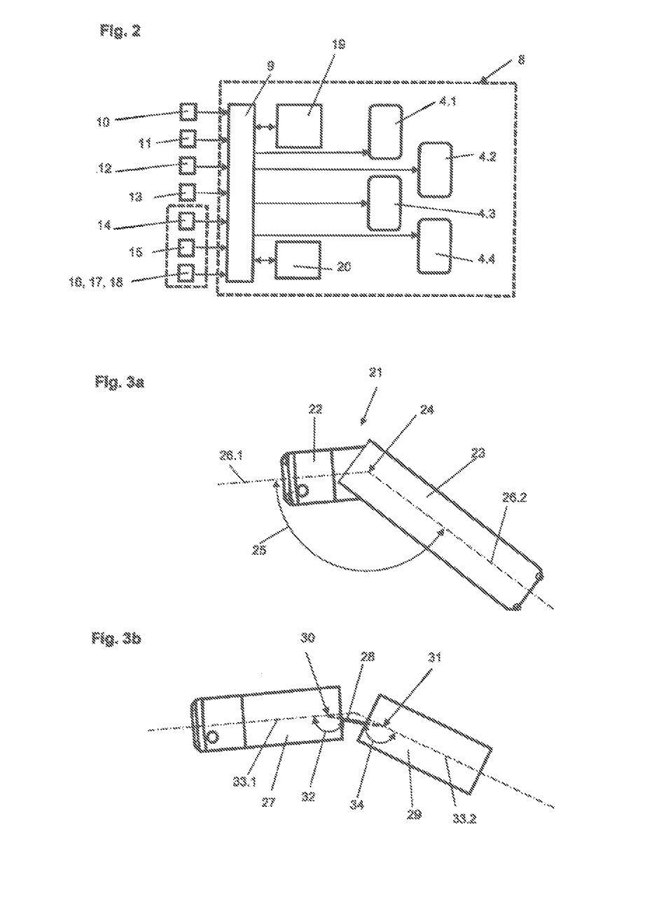

FIG. 2 shows an example of the arrangement for carrying out of the method according to the invention in a schematic diagram, wherein the functions are each shown in the form of function blocks. It should be noted here that the function blocks do not necessarily have to be implemented as hardware components. Rather, it is currently usual to design such components as software routines that are formed by means of data processing devices, wherein the same serve suitable sensors, actuators and switching means. The function blocks shown are in this case at least in part only formed temporarily, as the control devices used in vehicles usually contain data processing devices that are used for a wide variety of control and regulation tasks.

FIG. 2 shows a control device 8 containing a data processing device 9. By means of suitable connections the control device 8 cyclically polls a steering angle sensor 10 regarding the steering angle, a driving speed selector 11 regarding the direction of travel (forwards or backwards), a turn indicator 12 (right or left indicator activated?) to determine an approximated probable future steering angle and a speed sensor 13 regarding the speed of the vehicle. Depending on the type of vehicle, more devices can be polled, such as steering angle sensors 14 of any further steered axles of the vehicle that may be present regarding their steering angles, a navigation system 18 regarding the proposed route in order to derive therefrom an approximated future steering angle, for example at road junctions, crossings, etc., an articulation angle sensor 15 if the vehicle is an articulated vehicle, for example a tractor for a semitrailer or a front tow bar angle sensor 16 and a rear tow bar angle sensor 17 if it is a vehicle with a trailer.

The data processing device 9 uses the cyclically retrieved information mentioned above as initial data for steering simulations, wherein the data processing device 9 draws on a steering model that is stored in a memory 19 so as to be accessible thereto. In this case a steering model is to be understood to mean a software method with which the data processing device 9 cyclically determines the steering behaviour of the vehicle and from this the future required road space around the vehicle using the above-mentioned information as input data (the steering angle, the selected direction of travel, the future steering angle, which is roughly derivable from an activated turn indicator, and any other steering angles of additional steered axles, the future steering angle resulting from the proposed route, the articulation angle or the tow bar angles).

If the future occupied road space is determined, the data processing device 9 overlays the information that defines the future occupied road space with symbol information that it takes from a symbol memory 20, and with said combined information controls the projection devices 4.1, 4.2, 4.3, 4.4 already mentioned in connection with FIG. 1 (the reference is maintained in all examples). Said projection devices sweep over the respective associated parts of the area around the vehicle with a light projection (compare also FIG. 1) and illuminate the part of the area that is defined as the future occupied road space. How far ahead the expected occupied road space is made visible can be specified by the data processing device 9 using a time specification that, offset against the speed of the vehicle, yields a driving distance and that yields a future occupied road space using the steering model.

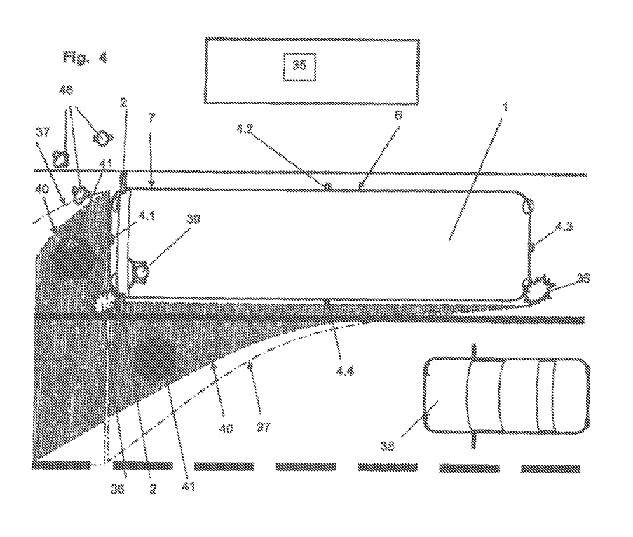

In order to clarify the meaning of the articulation angle for a tractor for a semitrailer, articulated buses or other articulated vehicles, in FIG. 3a a tractor 21 for a semitrailer is shown that consists of a truck chassis 22 and a semitrailer 23. The semitrailer 23 rests on a fifth-wheel coupling (not shown) of the truck chassis 22, so that a rotation point 24 is formed about which the semitrailer 23 rotates relative to the truck chassis 22. As can readily be seen, the truck chassis 22 and the semitrailer 23 adopt different articulation angles 25 relative to each other, wherein here the articulation angle 25 is defined as the angle between the central longitudinal axis 26.1, 26.2 through the truck chassis and the semitrailer.

If the vehicle is a vehicle combination of a truck and a trailer, there will be other conditions, as shown in FIG. 3b. Here a truck 27 is joined to a trailer 29 by means of a tow bar 28 in the sense of a classic vehicle combination. Because the tow bar 28 is rotatably attached to the truck 27 and is rotatably attached to the trailer 29 by means of the steering axle (not shown), a first rotation point 30 forms on the truck 27 and a second rotation point 31 forms on the trailer 29. This results in a front tow bar angle 32 between the tow bar 28 and the longitudinal axis 33.1 of the truck 27 and a rear tow bar angle 34 between the tow bar 28 and the longitudinal axis 33.2 of the trailer 29. Because said angles can be of different sizes, the steering behaviour of the vehicle combination also depends on the front tow bar angle 32 and the rear tow bar angle 34 in addition to the steering angle of the truck 27.

Taking into account the circumstances stated above, the method will be explained below using a few everyday traffic situations, during which the description of FIGS. 1 and 2 will also be relied on.

FIG. 4 shows the city bus 1 at a bus stop 35 with reference to the representation in FIG. 1. The city bus 1 is ready to depart and has the left indicator 36 activated; a steering angle has not yet occurred. From the circumstance of the activated indicator 36, the data processing device 9 (FIG. 2) predicts an imminent steering angle to the left and assumes a range of steering angles that can be specified in software for the calculation of the future occupied road space. Using said assumed range of steering angles, the data processing device determines an area defined in advance as the future occupied road space during a simulation using the steering model from the memory 19 (FIG. 2), and using this the data processing device controls the first projection device 4.1 and the fourth projection device 4.4. Said projection devices illuminate, by means of suitable light emission, the area identified in FIG. 4 by means of a dash-dotted outline 37 so as to be perceptible to other road users, for example the driver of the vehicle 38 and the people 48. The type of illumination is yet to be discussed.

Furthermore, it will be assumed that following the start of the city bus 1 by its driver 39, steering will be carried out and said steering will be input as the steering angle from the cyclical polling of the steering angle sensor 10 (FIG. 2) into the steering simulation and hence into the determination of the actual future occupied road space. Because the actual future occupied road space is always smaller than the area assumed in advance (see above) as the provisional future occupied road space, the projection is progressively adapted to the actual conditions. After carrying out the adjustment, the region shown in FIG. 4 with a dot pattern and enclosed by a dashed line 40 is perceptibly illuminated by the first projection device 4.1 and the fourth projection device 4.4. In addition, two STOP symbols 41 appear on the area illuminated by the projection, being oriented such that they can be read by road users (people 48, driver of the vehicle 38) that are moving towards the danger area.

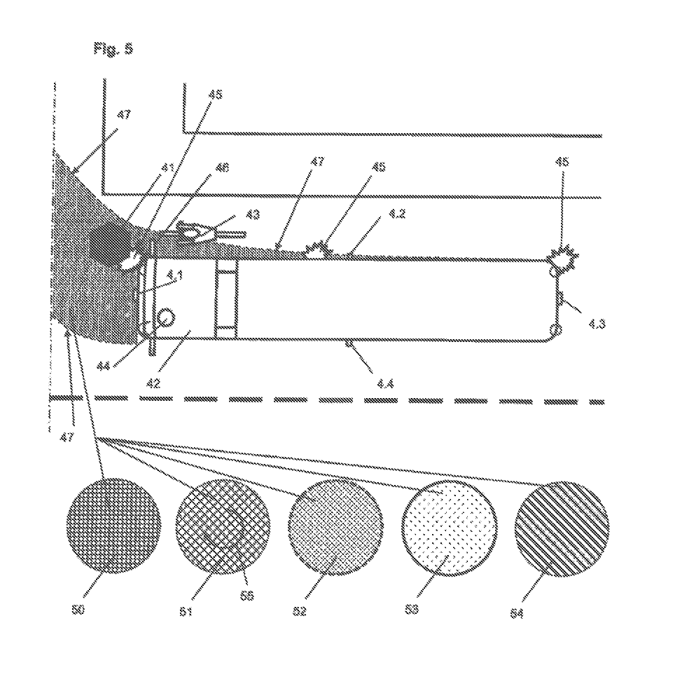

The representation in FIG. 5 shows a second potential accident traffic situation such as occurs daily. At a road crossing a truck 42 is travelling, in this case a tractor for a semitrailer, which is intending to turn right and is indicating this by means of the activated right indicator 45. A cyclist 43 is travelling beside the truck in a position in which he can only be poorly seen in the right side mirror 46 if at all by the truck driver 44. Although the truck driver 44 has not yet caused a steering angle, the data processing device 9 (FIG. 2), triggered by the activated right indicator 45, predicts an imminent steering angle to the right and assumes a range of steering angles that can be specified in software for calculation of the future occupied road space. Using said assumed range of steering angles, the data processing device determines, during a simulation using the steering model from the memory 19 (FIG. 2), an area provisionally defined as the future occupied road space and using said area controls the first projection device 4.1 and the second projection device 4.2, which illuminate by suitable light emission the occupied area identified in FIG. 5 by means of a dashed outline 47 and a dot pattern so as to be perceptible by other road users, for example the cyclist 43. As can be seen from the illustration, the cyclist 43 is already in the danger area and could, if he does not change his position and the truck driver 44 does not recognize the danger, be knocked off his cycle or run over by the rear right wheels of the truck 42. The projection of the provisional occupied future road space, together with the superimposed projection of a STOP symbol 41, unmistakably shows the cyclist 43 that he is in the danger area and gives him the opportunity to move to a safe distance from the truck 42.

Where the projection devices 4.1 to 4.4 repeatedly mentioned above are concerned, different technologies can be used to implement them. These range from the use of a conventional illumination body with suitable optics radiating through a variable aperture, wherein its aperture is controlled such that it forms an image of the future occupied road space as a light surface projected onto the road, through stroboscopic flashlights as illumination bodies with similar optics and aperture to laser projectors with one or a plurality of laser sources and one or a plurality of deflecting devices for the laser beam or the laser beams. However, laser projectors are preferably used as projection devices because of the high light density, focussing and controllability or deflectability of the beam. Because all the above-mentioned technologies are available on the market, a detailed description is not required.

If it is now assumed for the example according to FIG. 5 that projection devices 4.1 to 4.4 of the mentioned laser technology are being operated, there is a variety of options for designing the area defined as the future occupied road space. Some design examples are shown in circles at the bottom in FIG. 5.

Example 50 shows a raster-like structure, wherein the raster lines, which symbolise the path of the deflected laser beam, are closely meshed and intersect at right angles. A high light density results for the human eye for a comparatively low laser power as a result of the intersections and the fine meshing. The same applies to example 51, the mesh width being selected to be greater here, which is compensated, however, by the constant change of orientation of the raster indicated by means of arrow 55.

Example 52 shows another option for the design. In this case a dot raster generated by means of a pulsed laser is shown, wherein the illuminated area is bounded by a bold intermittent outline. Such a design makes the limits of the future occupied road space particularly clear. The same applies to the example 53; in this case the outline is not interrupted and the dot raster is less dense, so that the boundary of the future occupied road space is particularly emphasised.

Finally, there is the option of using a less sharply focussed laser beam, which forms a line pattern with broad lines as example 54 shows.

The above examples only show a small segment of the design options regarding the illumination of the area indicating the future occupied road space. For all configurations of the illumination, the intensity of the laser beam must be chosen to be lower than a magnitude that is hazardous to health.

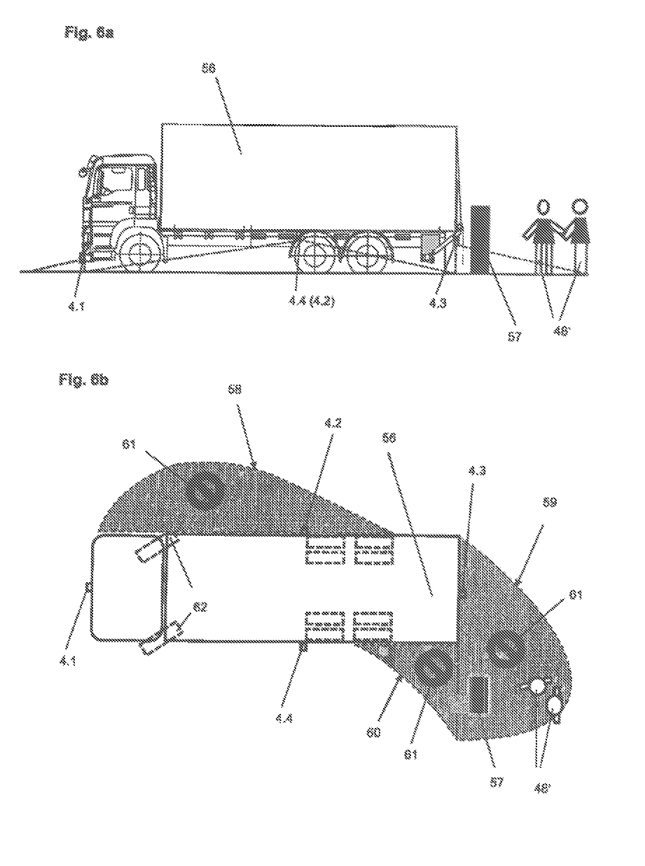

As a further safety measure, as already shown at the bottom in FIG. 1 and as is also apparent from FIG. 6a, which is described in detail below, the mounting position, in particular for laser projectors, is to be selected to be as far as possible on the lower edge of the body with a radiation direction towards the road surface. Regarding the number of projection devices to be mounted, this depends on the objective that is being sought. If for example only the departure of a city bus from a stop is to be protected, a projection device disposed on its left long side is sufficient; if in addition people in front of the city bus are to be warned, a projection device on its front is necessary (cf. FIG. 4). For warning cyclists for example when a truck is turning right, likewise only one projection device on its right long side is sufficient. If road users in the front region of the truck are also to be warned, an additional projection device on its front is necessary (cf. FIG. 5).

In certain cases, for all-round protection it can be necessary to use even more than four projection devices. This is the case for example for semi-trailers or trucks with trailers. On the one hand the truck chassis in the case of a tractor for a semitrailer can also be driven on its own, i.e. without a semi-trailer, likewise the truck without a trailer. On the other hand, when driving as a combination, the articulation of the semi-trailer or trailer, for example when manoeuvring, prevents a projection device that is only disposed on both sides on the truck chassis or truck from illuminating the future occupied road space in the region obscured by the semi-trailer or trailer. In these cases, four projection devices are to be provided on the towing vehicle or on the truck and three on the semi-trailer or trailer.

In order to show the conditions when manoeuvring a distribution vehicle, such a distribution vehicle 56 is shown in FIG. 6a. There are projection devices 4.1, 4.2, 4.3, 4.4 on its lower body edge. The projection device illumination cones are each indicated by dashed lines. There are people 48′ and a package 57 behind the distribution vehicle 56.

As FIG. 6b shows using the position of the front wheels 62, the driver of the distribution vehicle 56 has already carried out a steering action and wants to reverse. For this purpose he has operated a driving speed selector 11 (FIG. 2) and engaged a reverse gear. From polling the steering angle sensor 10 and the driving speed selector 11 (each in FIG. 2), the data processing device 9 (FIG. 2) determines the steering angle and the direction of travel and simulates reversing by the steering model and the steering angle as an input variable (see the description of FIG. 2 for this). The result of the simulation is a definition of the regions that will be travelled over by the distribution vehicle 56 when reversing. Said information is superimposed on a graphical symbol and the projection devices 4.2, 4.3, 4.4 are controlled by the combination and in turn project the future occupied road space onto the surface of the ground surrounding the distribution vehicle. During this the projection device 4.2 projects the first region 58, the projection device 4.3 projects the second region 59 and the projection device 4.4 projects the third region 60. An overlaid symbol 61 that signals “do not enter!” is shown in each of the above-mentioned regions. As is apparent from the illustration, the people 48′ and the package 57 are in the required road space, and the people 48′ are made aware of this by the light projection. At the same time the driver of the distribution vehicle 56 can recognize in the rear view mirror that the planned driving maneuver cannot be carried out with the selected steering angle and has the option of correcting the steering angle, to some extent interactively, such that his reversing maneuver can be carried out. This is interactive because the effect of the change of the steering angle can be directly read off the light projection.

### Reference Character List

1 city bus
2 side mirror
3 driver
4.1, 4.2, 4.3, 4.4 first to fourth projection device
4.11, 4.21, 4.31, 4.41 first to fourth radiation cone
4.12, 4.22, 4.32, 4.42 first to fourth area
5 road surface
6 rear entry door
7 front entry door
8 control device
9 data processing device
10 steering angle sensor
11 driving speed selector
12 turn indicator
13 speed sensor
14 steering angle sensor
15 articulation angle sensor
16 front tow bar angle sensor
17 rear tow bar angle sensor
19 memory
20 symbol memory
21 tractor for a semitrailer
22 truck chassis
23 semitrailer
24 rotation point
25 articulation angle
26.1, 26.2 central longitudinal axes
27 truck
28 tow bar
29 trailer
30 first rotation point
31 second rotation point
32 front tow bar angle
33.1, 33.2 longitudinal axes
34 rear tow bar angle
35 bus stop
36 left indicator
37 dash-dotted outline
38 vehicle
39 driver
40 dashed line
41 STOP symbol
42 truck
43 cyclist
44 truck driver
45 right indicator
46 right side mirror
47 dashed outline
48, 48′ people
50 to 54 first to fourth example
55 arrow
56 distribution vehicle
57 package
58 first region
59 second region
60 third region
61 symbol

1. A method for warning road users of potential danger areas caused by a vehicle that is carrying out a driving maneuver, the method being performed by a control device and comprising the steps of:
cyclically retrieving a steering angle of the vehicle using at least one steering angle sensor,
cyclically retrieving a direction of travel of the vehicle from a driving speed selector,
cyclically determining, by a steering model of the vehicle that is accessible to the control device, information about a future occupied road space that will be occupied in the future within a specifiable time and speed in the event of maintaining the steering angle using the steering angle and the direction of travel, and
controlling at least one projection device, based on the information about the future occupied road space, to project a light projection onto a surface of ground surrounding the vehicle such that at least part of the future occupied road space is made visible by the light projection.

2. The method according to claim 1, further comprising the step of cyclically retrieving the actual speed of the vehicle using a speed sensor and using the same to determine information about the future occupied road space.

3. The method according to claim 1, further comprising the step of cyclically polling the turn indicator and, with the turn indicator activated and the vehicle stationary and/or the steering angle unchanged, predicting a future driving manoeuvre in the direction specified by the turn indicator, and specifying a road space as the future occupied road space from memory values, and transforming the specified road space into and actual future occupied road space as defined by the actual steering angle while the vehicle is moving.

4. The method according to claim 1, further comprising the step of cyclically retrieving the route proposed by a navigation system and initially using the steering angle to be assumed when following the proposed route to determine the future occupied road space, and transforming the assumed future occupied road space into and actual future occupied road space defined by the actual steering angle while the vehicle is moving.

5. The method according to claim 1, further comprising the step of cyclically determining an articulation angle of the vehicle and using the articulation angle to determine the future occupied road space.

6. The method according claim 1, wherein, for vehicles with trailers, the method further comprises the step of cyclically determining a front tow bar angle and a rear tow bar angle of a trailer tow bar and using the same to determine the future occupied road space.

7. The method according to claim 1, further comprising the step of overlaying the projection of the future occupied road space with at least one item of additional information.

8. The method according to claim 7, wherein the projection of the future occupied road space and the additional information are carried out alternately

9. The method according to claim 7, wherein the overlaid information is graphical information.

10. The method according to claim 7, wherein the graphical information is a STOP symbol.

11. The method according to claim 1, wherein the projection of the future occupied road space takes into account a safety distance.

12. An arrangement for warning road users of potential danger areas caused by a vehicle that is carrying out a driving manoeuvre, the arrangement comprising:
a data processing device provided as a control device, which determines a steering angle using a steering angle sensor, determines a selected direction of travel using a driving speed selector, calculates a future road space to be occupied within a specifiable time from at least the steering angle and the selected direction of travel; and
a steering model of the vehicle stored in a memory of the control device, and
at least one projection device on the vehicle projecting a light projection onto a surface of ground surrounding the vehicle to indicate at least part of the future occupied road space, the at least one projection device being controlled by the control device based on the information about the future occupied road space.

13. The arrangement according to claim 12, wherein the at least one projection device contains at least one laser light emitting laser source and at least one deflecting device that deflects a laser beam within specified limits.

14. The arrangement according to claim 13, wherein an intensity of the at least one laser light emitting laser source is controllable.

15. The arrangement according to claim 13, wherein the at least one laser light emitting laser is disposed on the vehicle such that direct dazzling of road users in road traffic is excluded to a certain extent.

16. The arrangement according to claim 13, wherein the intensity and/or the deflection of the laser beam is controlled such that a radiation dose when the laser beam sweeps across a human eye lies below a dose that is hazardous to the health of human eyes.

17. The arrangement according to claim 13, wherein the deflection unit is designed such that the laser beam sweeps across the area occupying the future occupied road space in a raster pattern

18. The arrangement according to claim 17, wherein the deflection unit is designed such that at least two successive rasters are selected such that the lines of the rasters intersect.

19. The arrangement according to claim 13, wherein the deflection unit is designed such that the laser beam traces the outline of the area identifying the future occupied road space.

20. A vehicle with an arrangement according to claim 12.
